(19) United States
(12) Patent Application Publication
(10) Pub. No.: US 2009/0308348 A1
(43) Pub. Date: Dec. 17, 2009

(54) CONTINUOUS IGNITION SYSTEM FOR INTERNAL COMBUSTION ENGINE THROUGH PLASMA

(75) Inventor: Dante Raul Guerrero, Sao Paulo (BR)

Correspondence Address: MCKEE, VOORHEES & SEASE, P.L.C., 801 GRAND AVENUE, SUITE 3200, DES MOINES, IA, 50309-2721, US

(73) Assignee: VIVALDO MAZON, Mogi Mirim (BR)

(21) Appl. No.: 12/299,978

(22) PCT Filed: Aug. 16, 2006
(86) PCT No.: PCT/BR2006/000164

§ 371 Date: May 6, 2009

(30) Foreign Application Priority Data
May 8, 2006 (BR) PI 0601626-0

(51) Int. Cl. F02B 47/02; F02B 51/00; H01T 13/08

(52) U.S. Cl. 123/25 A; 123/536; 123/169 R

(57) ABSTRACT

Particularly comprising a voltage oscillator (1) and triplicator (2) system, to be installed in a internal combustion engine (M) or similar, thus dispensing with the existing distributors and similar devices (not represented), which enables, through low or high voltage, the formation of a continuous electric arc inside the combustion chamber (3) that receives the mixture of air, additive water in the combustion, thus enabling the ozonization of the emulsion which, during the optimal compression breaks out the dielectric resistance, generating the discharge arc using a specific continuous ignition spark plug (V) activated by the fourth state of matter, i.e., plasma.

This application is for an Invention Patent of an hitherto unknown “CONTINUOUS IGNITION SYSTEM FOR INTERNAL COMBUSTION ENGINE THROUGH PLASMA”, mainly for a system that aims at promoting the ignition of the internal combustion engine with water mixed in the combustion through a continuous electric arc that at a certain pressure condition, upon compression of the cylinder makes the molecules of the mixture reach a balance point that offers less electrical resistance, closing an evaporation arc, using for this purpose a specific spark plug in synchronicity with the plasma generated by the above mentioned arc. The claimed system comprises preferably a triplicator and a voltage oscillator connected to the positive pole of the battery or generator and the negative pole connected to a switch that can be either a rotor or even an optical sensor; or even comprises a battery connected to a high voltage generator which, on its turn, is connected to the specific plugs that operate by the plasma or in a third embodiment with a battery or generator connected to the oscillators and triplicators connected to said spark plugs.

The system presents several advantages related to various aspects at practical, operational and functional levels, such as: combustible saving, ecologically friendly, higher potency and torque, longer engine life cycle, all such advantages sought for a long time by the automobile industry.

In general, this system can be installed to any type or similar internal combustion engines through small adjustments, such as, for instance the amount of water mixed to the combustion, requiring only a special spark plug operating on plasma.

It has been known for a long time that solutions are being sought for several events in internal combustion engines, such as loss of power, combustible consumption, and pollution reduction, among others. In this sense, the automobile industry spends millions of dollars in projects that aim at increasing the efficiency, dependability and life cycle of the ignition systems, either by using electric and/or electronic devices.

Thus, the current state of the art although deeply studied by the automotive industry has not yet found a solution capable of conceptually revolutionizing the combustion engines ignition technique.

Internal combustion engines, particularly using gas or alcohol, basically have a combustion chamber that receives a mixture of combustible vapor and air, which is compressed and ignited by a spark in the spark plugs. Said spark plugs exist since the internal combustion engines invention and are responsible for 02 basic key and essential functions in the engine:

conduct the electric high voltage into the dry combustion chamber, turning it into a spark that ignites the air/combustible mixture;

remove part of the heat in the combustion chamber generated by burning the air/combustible mixture.

All the investment made has not yet been able to generate sufficient power to make the ignition spark “leap” further than one millimeter between the electrode and the ceramic body of the spark plug.

As a result, the gases produced during the explosion expand acting on the crankshaft and then being discharged through the exhaust pipe.

There is no need of spark during the diesel stage, combustion being obtained through a pressure×temperature ratio.

As a rule, there is an approximate 66% loss in conventional combustion systems related to thermodynamic or aerodynamic loss, friction, load, etc.

The herein proposed ignition system represents a conceptual revolution in this industry, comprising basically an oscillator and a triplicator activated by a low voltage connected valve command signal, said signal can be mechanical (rotor) or even electronic (optical sensor) generating an ionic discharge arc within the combustion chamber, with a continuous spark during PMS, expansion and exhaustion, in short producing an ozonization during the aspiration and compression, thus catalyzing the wet combustion.

During the aspiration and compression stage, the potential differential is not sufficient to close the electric arc, since the resistive stage in the rotor path is not sufficient to bring about the ignition in the mixture or sufficient compression to react, in face of the resistance of the combustible or ignition emulsion inside the cylinder. On the other hand, there is an ozone (O₃) production, which enables the optimal reaction between the O₃ and hydrocarbons.

The same continuous ignition electric arc can be directly connected to a high voltage generating source and then directed to the plasma activated spark plug; or even to a battery or a generator, which positive pole is directly connected to the oscillator triplicator set routed to the spark plugs.

Summarizing, the proposed systems results in a series of advantages, such as:

it technically burns out the combustible with a thermodynamic gain;

it improves performance (torque×potency);

it is non-pollutant;

it is independent from the ignition system;

it reduces the engine work temperature;

The lubricant works below its critical temperature limit;

it reduces consumption.

The invention is explained below with reference to attached drawings, which are depictured in an illustrative and not in a limitative way:

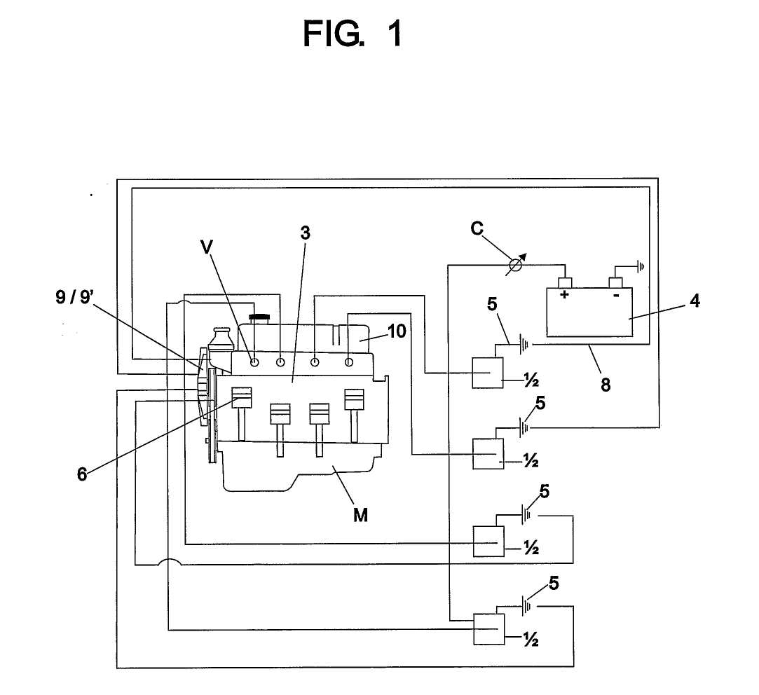

FIG. 1: Schematic view of the continuous ignition system for internal combustion engine through plasma, connected to the positive pole of the battery or generator and the negative pole to a mechanical or electronic switch connected to the negative;

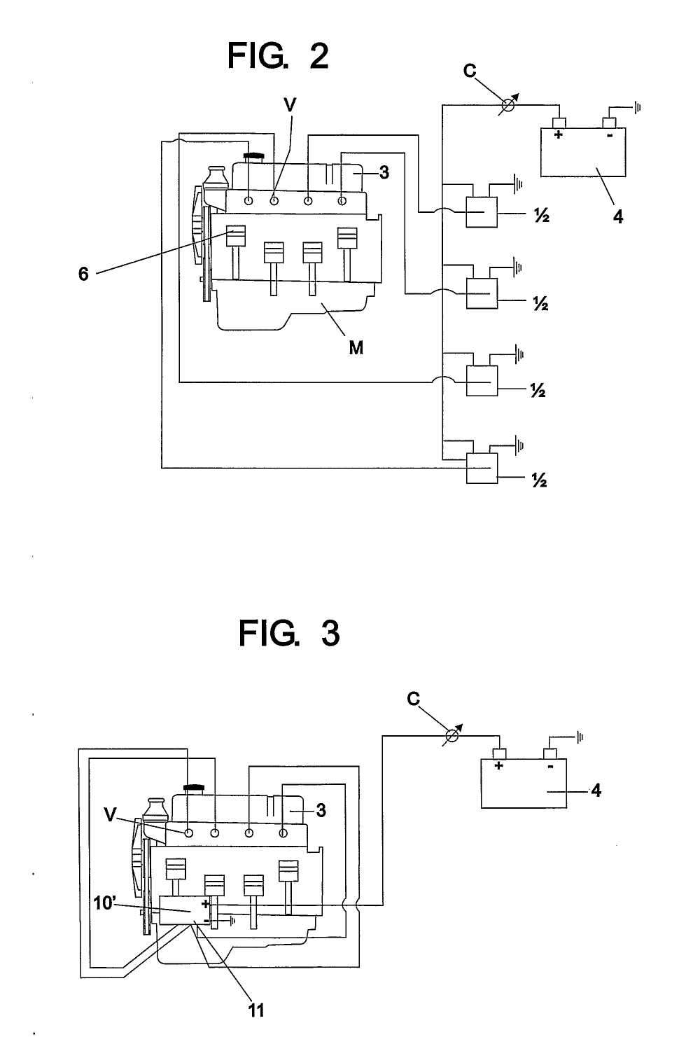

FIG. 2: Schematic view of the continuous ignition system for internal combustion engine through plasma, with oscillator and triplicator sets connected to the positive pole of the battery or generator;

FIG. 3: Schematic view of the continuous ignition system for internal combustion engine through plasma, connected to a high-voltage generator.

The “CONTINUOUS IGNITION SYSTEM FOR INTERNAL COMBUSTION ENGINE THROUGH PLASMA”, object of this Invention Patent application, basically comprising a voltage oscillator (1) and triplicator (2) set to be installed in an internal combustion engine (M) or similar, dispensing with the existing distributors and similar devices (not represented), which enables through low or high voltage the creation of a continuous electric arc inside the combustion chamber (3), which receives the air/combustible mixture with addition of additive water, thus enabling the ozonization of the emulsion that, upon optimal compression breaks the dielectric resistance and generates the discharge arc, using a specific continuous ignition spark plug (V) activated by the forth stage of the matter, i.e., plasma.

More specifically, the system preferably comprises a voltage oscillator (1) and triplicator (2) set connected to the positive pole (+) of the battery or generator (4) going through a contact switch (C), and the negative (−) is connected to a low voltage source (5) in such a way to create a continuous electric arc inside the combustion chamber (3) i.e., a discharge arc that provides through specific spark plugs (V) the ignition through the plasma formed, activating said spark plugs (V) through the electric resistance in the air/combustible and water mixture, during the compression, expansion, exhaustion and admission stages, within a four stages cycle. Variations in temperature and pressure of the gases during the above described stages generate ohmic resistance variations between the cathode (spark plug) and the anode (piston), in such a way that the continuous electric arc, in other words, the discharge arc (corona), breaks out the dielectric rigidity at the optimal time, more specifically, when the piston (6) is at Top Dead Center (TDC). Thus, the claimed system dispenses with analogical or binary sensors (not represented) in order to create ignition at the optimal point, as in conventional systems.

The installation of the water feeding reservoir (not represented), essential to the system operational capability, which can be captured before the electrical engine or within the vacuum chamber of the engine through capillaries (not represented). The addition of water to the combustion is important to make up for the high thermal ratio obtained by the optimal burn of the mixture based on this system, thus directing this heat dissipation to the interior of the combustion chamber (3) which, during the Otto cycle, originally operates under varied pressure and start operating under an uniform pressure, since the cylinder always operates full of vapor.

In a preferred embodiment, the voltage oscillator (1) and triplicator (2) set, as already mentioned, is fed by a low voltage source (5) with a switch that is negative (8) represented by a two stages mechanic rotor (9), with half neutral stage and half conductor stage operated through the valve command (10), or in any other embodiment that services a specific type of engine (M). The same negative switch can be an optical sensor (9′) or another similar electronic device.

In a second embodiment, the system can be performed by the voltage oscillator (1) and triplicator (2) set connected to the positive pole (+) of the battery or generator (4) going through a contact switch (C), and directly connected to the specific spark plug (V) activated by the plasma generating the continuous electric arc, thus dispensing with the need for the switch (9 and 9′) mentioned in the preferred embodiment.

In a third embodiment, the continuous electric arc is obtained by means of a high voltage generating source (10′) connected to the positive pole (+) of the battery (4) or to any generator, and after going through the contact switch (C), through a module (11) it branches out to the spark plugs (V) thus enabling the formation of the continuous electric arc inside the combustion chamber (3), which, in the balanced conditions largely described above contributes to the execution of the explosion.

In general lines, the system using the same invention concept, i.e., the continuous electric arc inside the cylinder, obtained through low (5) or high (10′) voltage together with the addition of water in the combustion, forms an discharge arc (corona) during the expansion and the exhaustion thus originating ozone during the aspiration and compression and catalyzing combustion. With small adjustments, it is possible to adapt this system to other engine stages, as for instance, diesel.

1) “CONTINUOUS IGNITION SYSTEM FOR INTERNAL COMBUSTION ENGINE THROUGH PLASMA”, to be installed in an internal combustion engine (M) or similar, dispensing with the existing distributors (not represented), wherein said system is made feasible through low (5) or high (10′) voltage forming a continuous electric arc inside the combustion chamber (3) at the surface of the piston that receives a mixture of air, combustible with addition of additive water, thus enabling the ozonization of the emulsion, which, at the optimal pressure breaks out the dielectric resistance and generates the discharge arc using for this a specific continuous ignition spark plug (V) activated by the fourth stage of matter, i.e., plasma.

2) “CONTINUOUS IGNITION SYSTEM FOR INTERNAL COMBUSTION ENGINE THROUGH PLASMA”, according to claim 1, wherein said system preferably comprises a voltage oscillator (1) and triplicator (2) set fed by a low voltage source (5) connected to positive pole (+) of the battery or generator (4) going through a contact switch (C), which switch is the negative (8) represented by a two-stages mechanic rotor (9), being half stage neutral and half state conductor, activated by the command of valve (10), or in any other embodiment that services a specific type of engine (M).

3) “CONTINUOUS IGNITION SYSTEM FOR INTERNAL COMBUSTION ENGINE THROUGH PLASMA”, according to claim 2, wherein said system comprises a negative switch, which can be an optical sensor (9′) or another similar electronic device.

4) “CONTINUOUS IGNITION SYSTEM FOR INTERNAL COMBUSTION ENGINE THROUGH PLASMA”, according to claim 1, wherein in a second embodiment, the system is able to be performed by a voltage oscillator (1) and triplicator (2) system connected to the positive pole (+) of the battery or generator (4) going through a contact switch (C) and directly connected to the specific spark plug (V) activated by plasma, thus generating the continuous electric arc, dispensing with the switch (9 and 9′) mentioned in the preferred embodiment.

5) “CONTINUOUS IGNITION SYSTEM FOR INTERNAL COMBUSTION ENGINE THROUGH PLASMA”, according to claim 1, wherein in a third embodiment, the continuous electric arc is obtained through any high voltage generating source (10′) connected to the positive pole (+) of the battery (4) or any generator, after going through a contact switch (C), through a module (11) that branches out to the spark plugs (V) causing the formation of a continuous electric arc inside the combustion chamber (3) that provides to the explosion.

6) “CONTINUOUS IGNITION SYSTEM FOR INTERNAL COMBUSTION ENGINE THROUGH PLASMA”, according to claim 1, wherein through small adjustments, this system can be adapted to other engines cycles, as for instance, diesel.
